(19) United States
(12) Patent Application Publication
(10) Pub. No.: US 2007/0150531 A1
(43) Pub. Date: Jun. 28, 2007

(54) Apparatus and method for generating random number using digital logic

(76) Inventor: Yong-Sung Jeon, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 10/584,158

(22) PCT Filed: Jul. 29, 2004
(86) PCT No.: PCT/KR04/01911

§ 371 Date: Jun. 22, 2006

(30) Foreign Application Priority Data
Dec. 23, 2003 (KR) 10-2003-0095373

(51) Int. Cl. G06F 7/58

(52) U.S. Cl. 708/250

(57) ABSTRACT

An apparatus and method for generating random numbers using digital logic are provided. The apparatus includes a shift register which sequentially moves bit values stored therein, a feedback circuit which performs a predetermined logic operation on the bit values stored in the shift register to generate a feedback signal, an external signal generation circuit which generates an external signal input to the shift register, and an input logic circuit which performs a predetermined logic operation on the feedback signal and the external signal and inputs a result of operation to the shift register. The method includes sequentially moving bit values stored in a shift register, (b) performing a predetermined logic operation on the bit values stored in the shift register to generate a feedback signal, (c) generating an external signal input to the shift register, and (d) performing a predetermined operation on the feedback signal and the external signal and inputting a result of the operation to the shift register.

### TECHNICAL FIELD

The present invention relates to an apparatus and method for generating random numbers, and more particularly, to an apparatus and method for generating random numbers using digital logic.

### BACKGROUND ART

An apparatus for generating random numbers is applicable to various fields. For example, it can be used when generating a key for an encrypting operation. In this case, the performance of this apparatus is very important to guarantee a safe encrypting operation.

To generate random numbers, the apparatus must have a complexity that causes generation of any possible value that can be statistically generated, and randomness that prevents random values from being easily expected beforehand. Conventionally, random numbers are generated using either a physical random number generation method using noise components caused by physical phenomena or a pseudo random number generation method that generates a series of numbers that are mathematically defined.

In the physical random number generation method, physical random numbers are generated using physical phenomena such as thermal noise, temperature, and changes in power supplied by a power supply. Thus, although physical random numbers are cryptologically safe, this method requires the use of an amplifying circuit and an analog circuit, since the magnitude of a signal caused by physical phenomena is very small.

However, because the analog circuit is capable of generating only random signals, this method further requires a collector logic that samples analog signals and collects a result of sampling so as to obtain digital random numbers that are statistically balanced and have complexity.

Conventional collector logics may be unsuitable for a complex encrypting operation since they require a lot of time to generate a random number stream. Also, a random number generating apparatus using an analog circuit is disadvantageous in that it is difficult to manufacture and a power source required to generate random numbers is easily controlled by an attacker. Therefore, a lot of experimentation and effort still needs to be made to improve the performance of the random number generating apparatus.

The pseudo random number generation method uses only digital logic and thus is easy to be accomplished. For this reason, this method is adopted by many systems.

Conventionally, the pseudo random number generation method uses a linear congruential generator algorithm or a linear feedback shift register (LFSR).

### DISCLOSURE OF INVENTION

### Technical Problem

In conventional pseudo random number generation method, a series of random numbers are obtained using a mathematically defined function and sequentially output. As a result, the random numbers that are to be generated are predetermined. Further, the random numbers are sequentially output in an order that repeats itself and then repeatedly output in the same order as they were output after a predetermined time, thus enabling expectation of the random numbers to be output. In other words, when the same value is input to the linear congruential generator algorithm, the same random numbers are obtained, and when the same initial value, i.e., a seed, is input to the LFSR, the order of the random numbers also repeats after a predetermined time.

Therefore, the pseudo random number generation method guarantees a complexity that causes generation of every possible value that can be statistically generated. However, this method does not satisfy the randomness aspect of random numbers, since the input of a specific initial value results in the generation of the same random numbers after a predetermined time. That is, random numbers that will be generated can be anticipated. Accordingly, a system using pseudo random numbers requires an additional process for randomly determining an initial input value.

### Technical Solution

The present invention provides an apparatus and method for easily generating digital random numbers with only digital logic while securing randomness that a physical random number generating apparatus can provide using an analog circuit.

To generate completely random numbers using only a digital circuit, in the present invention, (i) random values are output when a combination of an output of a feedback unit of a linear feedback shift register (LFSR) and a random signal value is input to the feedback unit, and (ii) clocks contain a jitter and when values of clocks are changed is determined by the jitter contained in the clocks.

### Advantageous Effects

Accordingly, it is possible to easily generate random numbers using only digital logic and obtain randomness as if the random numbers are generated with a physical random number generating apparatus using an analog circuit. Also, the complexity of random numbers are secured due to the characteristics of the LFSR which is a pseudo random number generating apparatus. That is, it is possible to obtain every possible value that can be statistically generated.

### DESCRIPTION OF DRAWINGS

The above and other aspects and advantages of the present invention will become more apparent by describing in detail exemplary embodiments thereof with reference to the attached drawings in which:

FIG. 1 is a schematic block diagram of an apparatus for generating random numbers using digital logic, according to an embodiment of the present invention;

FIG. 2 is a schematic block diagram of a 4-bit linear feedback shift register (LFSR) that includes a shift register and a feedback circuit of FIG. 1;

FIG. 3 is a block diagram of a 4-bit LFSR which is the same as the LFSR of FIG. 2 except that it further includes a fixed value prevention circuit;

FIG. 4 is a schematic block diagram of an example of a random signal generating circuit, shown in FIG. 1, that operates in response to two clocks generated by two individual sources;

FIG. 5 is a schematic block diagram of another example of the random signal generating circuit, shown in FIG. 1, that operates in response to rising and falling edges of two clocks generated by two individual sources; and

FIG. 6 is a flowchart illustrating a method of generating random numbers using digital logic, according to an embodiment of the present invention.

### BEST MODE

According to an aspect of the present invention, there is provided an apparatus for generating random numbers using digital logic, the apparatus comprising a shift register which sequentially moves bit values stored therein; a feedback circuit which performs a predetermined logic operation on the bit values stored in the shift register to generate a feedback signal; an external signal generation circuit which generates an external signal input to the shift register; and an input logic circuit which performs a predetermined logic operation on the feedback signal and the external signal and inputs a result of operation to the shift register.

The apparatus may further include a fixed value prevention circuit that generates a signal with a value that allows an output of the input logic circuit to have a different value to a value of an output of the shift register and inputs the generated signal to the input logic circuit, when a logic value of the external signal is equivalent to all the bit values stored in the shift register.

The signal output from the fixed value prevention circuit may be at logic high.

The external signal generation circuit may generate a random signal.

The random signal may be generated by sampling a sampled signal generated by a source that is different from a source of a sampling signal.

Sampling may be performed both at rising and falling edges of the sampling signal generated by a source that is different from a source of the sampled signal.

According to another aspect of the present invention, there is provided a method of generating random numbers using digital logic, the method comprising (a) sequentially moving bit values stored in a shift register; (b) performing a predetermined logic operation on the bit values stored in the shift register to generate a feedback signal; (c) generating an external signal input to the shift register; and (d) performing a pre-determined operation on the feedback signal and the external signal and inputting a result of the operation to the shift register.

During (d), the predetermined logic operation may be further performed on an output of a fixed value prevention circuit that allows the result of the predetermined logic operation to be different to the bit values of the shift register, when a logic value of the external signal is equivalent to all the bit values stored in the shift register.

The output of the fixed value prevention circuit may be at logic high.

The external signal may be a random signal.

The random signal may be generated by sampling a sampled signal generated by a source that is different from a source of a sampling signal.

Sampling may be performed both at rising and falling edges of the sampling signal generated by a source that is different from a source of the sampled signal.

### Mode for Invention

The present invention will now be briefly described for better understanding. A linear feedback shift register (LFSR) adopted by a conventional pseudo random number generating method uses a feedback circuit using a mathematically defined function and generates different series in each clock period by inputting an output of the feedback circuit to a shift register. However, as described above, the sequence of the series is fixed. To solve this problem, the present invention uses a sum of the output of the feedback circuit and a value of an external signal as an input value input to the shift register.

The characteristics of the LFSR when a value of the external signal is fixed to 0 are different to the characteristics of the LFSR when a value of the external signal is fixed to 1. More specifically, series are generated by the LFSR in the same order as series generated by the conventional LFSR, when the external signal has a value of 0. However, when the external signal has a value of 1, the sequence of the series generated by the LFSR is different from, rather than opposite to, the sequence generated when the external signal has the value of 0. Further, when the external signal has the value of 1, distribution of series generated by the LFSR has a degree of complexity equivalent to that of series obtained when the external signal has the value of 0. Accordingly, when the external signal has random values, series generated by the LFSR become unexpectable random numbers.

A conventional random number generating apparatus generates random numbers using only a recently generated random signal without maintaining randomness of a signal generated by an analog signal. In contrast, a random number generating apparatus according to the present invention changes a pattern on which changes in values of a series output from the LFSR are based, according to a random signal value while changing the values of the series. Therefore, randomness of random signal values can be maintained, and therefore, the LFSR is capable of generating unexpectable and complete random numbers when random numbers are required by software.

Accordingly, use of the LFSR according to the present invention guarantees randomness of the input external signal and generates an unexpectable series whenever random numbers are required. Thus, it is possible to easily generate a random external signal using only digital logic without an analog circuit.

According to the present invention, a random external signal input to the LFSR is generated by making one clock of clocks generated by two independent sources sample the other clock, using a jitter caused in a clock signal. Since the jitter occurs in the clock for a short time, the level of randomness of the random external signal generated using the jitter is lower than that of randomness of a conventional random signal generated using an analog circuit. Nevertheless, the jitter can be sufficiently sampled when random numbers are required and the LFSR outputs unexpectable values whenever the jitter is sampled. Accordingly, the random component of the jitter causes the LFSR to generate unexpectable random numbers.

Hereinafter, an apparatus and method for generating random numbers using digital logic according to exemplary embodiments of the present invention will be described with reference to the accompanying drawings. Like reference numerals represent like elements throughout the drawings.

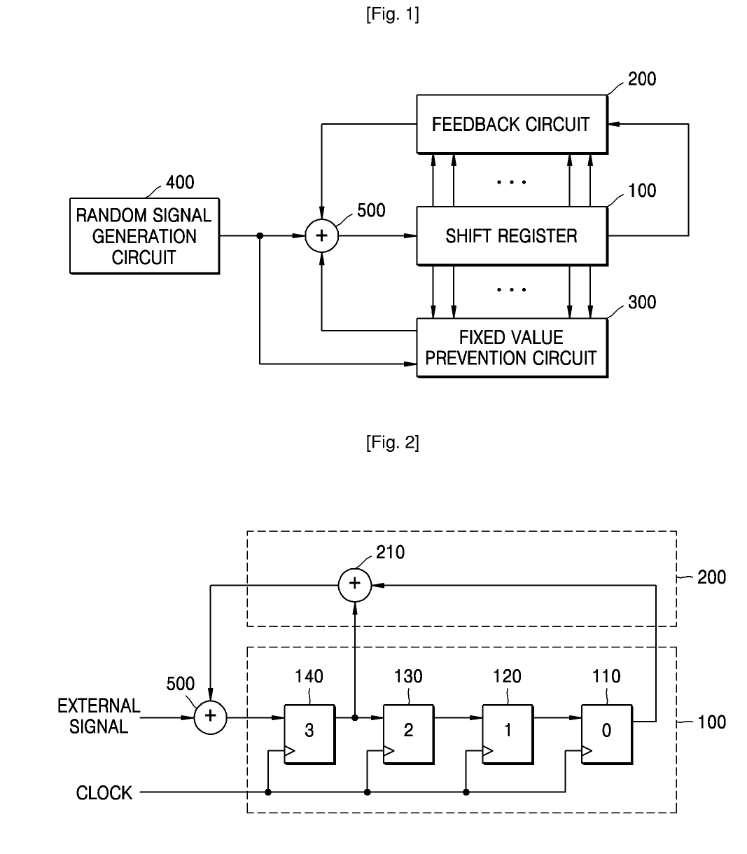

FIG. 1 is a block diagram of an apparatus for generating random numbers using digital logic, according to an embodiment of the present invention. The apparatus of FIG. 1 is divided into four element blocks. The four element blocks will now be described in terms their constructions and operations.

The apparatus of FIG. 1 includes a shift register 100, a feedback circuit 200, a fixed value prevention circuit 300, a random signal generation circuit 400, and an input logic circuit 500.

The shift register 100 sequentially moves bit values stored therein to the feedback circuit 200. Then, the feedback circuit 200 performs a predetermined logic operation on the bit values stored in the shift register 100 to generate a feedback signal. In this embodiment, the shift register 100 and the feedback circuit 200 are almost the same as those included in a conventional linear feedback shift register (LFSR). However, compared to the conventional LFSR, the apparatus of FIG. 1 generates a signal that is to be input to the shift register 100 using a different method, and further includes the fixed value prevention circuit 300, the random signal generation circuit 400, and the input logic circuit 500 that combines outputs of the feedback circuit 200, the fixed value prevention circuit 300, and the random signal generation signal 400 and transmits a result of combination to the shift register 100. Accordingly, random numbers generated by the apparatus of FIG. 1 have different operational characteristics from those generated by the conventional LFSR.

The operational characteristics of an apparatus for generating random numbers using digital logic, according to the present invention, will be described with reference to FIG. 2. FIG. 2 illustrates a 4-bit LFSR according to an embodiment of the present invention. The LFSR of FIG. 2 includes a shift register 100 and a feedback circuit 200 such as those installed in a conventional LFSR. The feedback circuit 200 performs an operation using a predetermined source polynomial, i.e., p(x)=x4+x3+1. The LFSR of FIG. 2 is differentiated from the conventional LFSR in that a signal input to the shift register 100 is generated from a combination of a signal output from the feedback circuit 200 and an external signal.

Returning to FIG. 1, the random signal generation circuit 400 generates an external signal input to the shift register 100. In this embodiment, the external signal is a random signal. Therefore, when a value of the external signal is fixed to 0, it is possible to obtain an effect similar to that obtained by inputting only the signal output from the feedback circuit 200 to the shift register 100, that is, an effect obtained when using the conventional LFSR. In this case, an initial seed value of the shift register 100 is 1010, values of first through fourth registers 110 through 140 are sequentially changed into 1010, 1101, 0110, 0011, 1001, 0100, 0010, 0001, 1000, 1100, 1110, 1111, 0111, 1011, 0101, and 1010, in response to clock input.

When the value of the external signal is fixed to 1, a value of the signal input to the shift register 100 is determined as a sum of a value of the signal output from the feedback circuit 200 and the external signal value of 1. In this case, when the initial seed value of the shift register 100 is 1010, values of the first through fourth registers 110 through 140 are sequentially changed into 1010, 0101, 0010, 1001, 1100, 0110, 1011, 1101, 1110, 0111, 0011, 0001, 0000, 1000, 0100, and 1010. That is, the sequence of series obtained when the external signal value is fixed to 1 is different from, rather than opposite to, the sequence of series obtained when the external signal value is fixed to 0. Further, the number of values generated by the series of the latter case, i.e., 24−1=15, is the same as that of values generated by the series of the former case. That is, they have the same complexity.

Accordingly, it is possible to generate unexpectable random values by combining the signal output from the feedback signal 200 and an external signal, a value of which is randomly, alternatively changed between 0 and 1, and inputting a result of combination to the shift register 100. Let us assume that the external signal has random values, and then, its value becomes fixed to a particular value or shows a regular pattern of change after a predetermined time, or that an external signal with random values and an external signal with a particular pattern of values are generated alternately and repeatedly at regular intervals. Even in this case, since the shift register 100 has already received the external signal with random values prior to receipt of the external signal with the particular value or particular pattern of values, it is difficult to estimate a value of an output of the shift register 100. In this connection, the apparatus according to the present invention is differentiated from a conventional apparatus for generating random numbers. In other words, when a signal with a particular pattern of values is input to the conventional apparatus a predetermined time after input of a signal with random values, random numbers generated by the conventional apparatus have a particular pattern, that is, they are expectable.

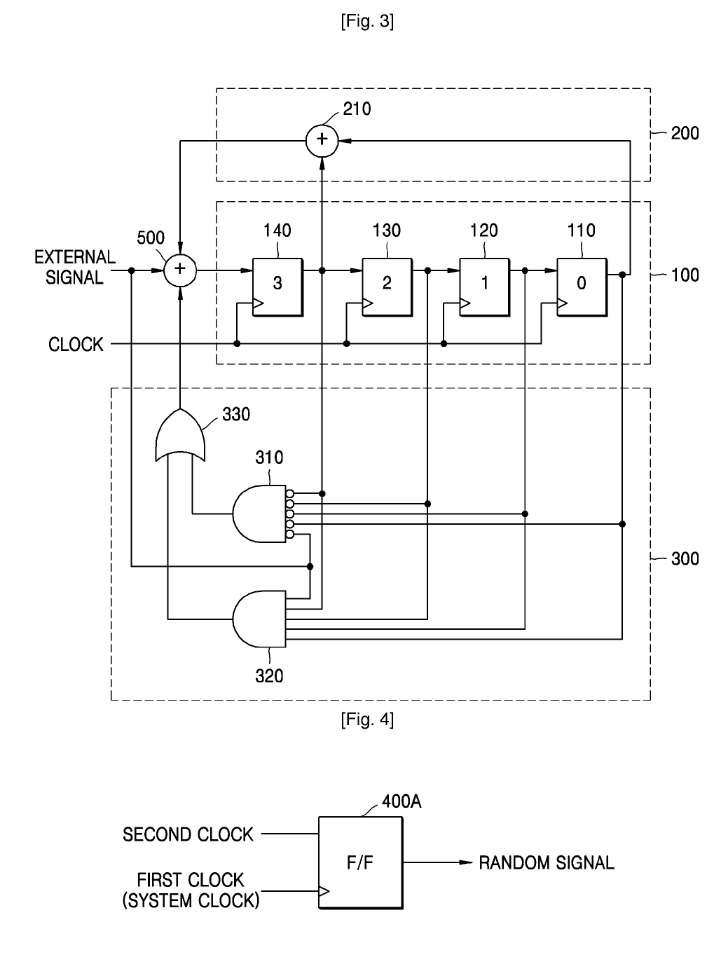

FIG. 3 illustrates a 4-bit LFSR that further includes a fixed value prevention circuit 300 compared to the 4-bit LFSR of FIG. 2. The fixed value prevention circuit 300 prevents series generated by a shift register 100 from being unchanged in response to clock input. In a conventional LFSR, only an output of a feedback circuit is input to a shift register, and thus, it is impossible to make a case where all values output from first through fourth registers are 0 except when initial seed values are 0000. That is, the values output from the first through fourth registers are changed to different values other than 0000 according to a predetermined pattern, in response to clock input.

In contrast, an LFSR according to the present invention generates random numbers by combining an output of a feedback circuit and an external signal. Accordingly, when the value of the external signal is 1, all outputs of the first through fourth registers 110 through 140 may have values of 0 as shown in the series described with reference to FIG. 2. If the value of the external signal is changed and fixed to 0 when input of the external signal with random values makes all the outputs of the first through fourth registers 110 through 140 have a value of 0, the outputs of all the shift registers of the shift register 100 are fixed to 0 regardless of a value of an input clock. Similarly, if the value of the external signal is fixed to 1 when input of the external signal with random values makes all the outputs of the first through fourth registers 110 through 140 have a value of 1, the outputs of all the shift registers of the shift register 100 are fixed to 1 regardless of a value of an input clock. Accordingly, the fixed value prevention circuit 300 is required to prevent values of outputs of the shift register 100 from being fixed to a particular value.

The fixed value prevention circuit 300 includes a first circuit 310 that inverts the outputs of the first through fourth registers 110 through 140 and the value of the external signal and performs an AND operation on the inversion results, or performs an OR operation on the outputs of the first through fourth registers 110 through 140 and inverts the OR operation result; a second circuit 320 that performs an AND operation on the outputs of the first through fourth registers 110 through 140 and the external signal value; and a third circuit 330 that performs an OR operation on outputs of the first and second circuits 310 and 320. An input logic circuit 500 combines the output of the third circuit 330, the external signal value, and the output of the feedback circuit 200, and inputs the result of combination to the shift register 100, thereby preventing outputs of the shift register 100 from being fixed to a particular value.

When the outputs of the first through fourth registers 110 through 140 have a value of 0000 and the external signal has a value of 0, an output of the feedback circuit 200 has a value of 0 without the fixed value prevention circuit 300. In this case, a sum of the output of the feedback circuit 200 and the external signal value input to the shift register 100 is also 0, and therefore, values of outputs of the shift register 100 are fixed to 0000. However, when the fixed value prevention circuit 300 is installed, the first circuit 310 inverts the outputs of the first through fourth registers 110 through 140 and the external signal value, performs an AND operation on a result of inversion, and generates a signal with a value of 1. When the signal with the value of 1 is input to the third circuit 330, the third circuit 330 also generates a signal with a value of 1. That is, the fixed value prevention circuit 300 outputs a signal with a value of 1. The value of the signal output from the fixed value prevention circuit 300, the external signal value, and a value of the output of the feedback circuit 200 are combined by the input logic circuit 500, thus obtaining a value of 1. The value of 1 output from the input logic circuit 500 is input to the shift register 100. In this case, the next values output from the first through fourth shift registers 110 through 140 are 1000 in response to clock input. Accordingly, it is possible to prevent the output values of the shift register 100 from being fixed to 0000 using the fixed value prevention circuit 300.

Similarly, when the values of the outputs of the first through fourth registers 110 through 140 are 1111 and the random signal value is 1, an output of the feedback circuit 200 has a value of 0 without the fixed value prevention circuit 300. Thus, the output value of the feedback circuit 200 and the random signal value are combined to obtain a value of 1. When a result of combination is input to the shift register 100, the output values of the shift register 100 are fixed to 1111. However, when the fixed value prevention circuit 300 is installed, the second circuit 320 performs an OR operation on the outputs of the first through fourth registers 110 through 140 and the external signal value, and generates an output with a value of 1. Accordingly, an output of the third circuit 330 also has a value of 1, and thus, the fixed value prevention circuit 300 generates an output with a value of 1. Then, the input logic circuit 500 combines the output value of the fixed value prevention circuit 300, the random signal value, and the output of the feedback circuit 200, and generates an output with a value with 0. Therefore, in response to clock input, the next values output from the first through fourth shift registers 110 through 140 are 0111. Accordingly, it is possible to prevent the output values of the shift register 100 from being fixed to 1111. In other words, the fixed value prevention circuit 300 generates an output with a value of 1 only when an output of the shift register 100 and the external signal have the same value. That is, it is possible to obtain an effect of inverting a value of a signal input to the shift register 100.

In this disclosure, an apparatus for generating random numbers according to the present invention is described with respect to a 4-bit LFSR, but the present invention is not limited to generation of random numbers with particular bit lengths.

FIG. 4 illustrates a flip-flop 400A in which one of two clocks, which are generated by two individual sources, is input to a clock terminal and the other clock is input to a data terminal, so that the other clock can be sampled by the clock input to the clock terminal to generate a signal with random values.

In general, a clock contains a jitter that changes a clock value, and when values of all clocks are changed are determined by the jitter contained therein. Accordingly, points of time when values of all clocks are changed are different from one another. The jitter is caused by physical phenomena such as changes in temperature and has random characteristics showing a Gaussian distribution. Therefore, the value of a signal generated when a jitter occurs in a clock during a sampling period, is randomly changed. Although the jitter occurs for a very short time and it is difficult to generate a signal with random values using the jit, input of a signal containing the jitter to an LFSR according to the present invention makes an output of the LFSR have an unexpectable value whenever a random signal is generated. Accordingly, only use of the random characteristics of a clock makes it possible to physically generate random numbers without an analog circuit.

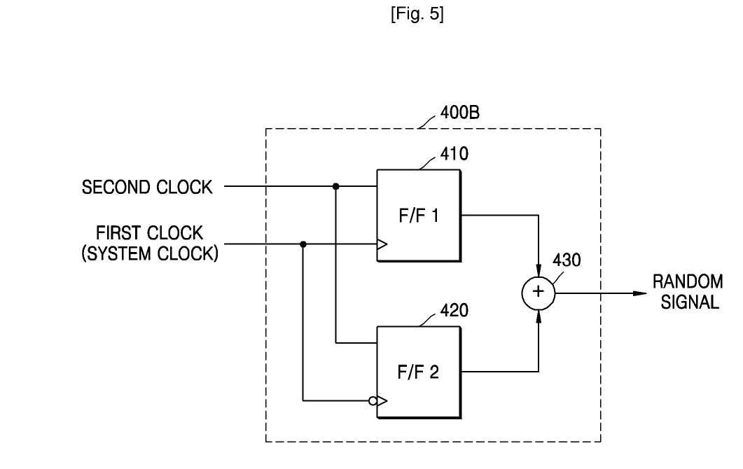

FIG. 5 illustrates an apparatus 400B for generating random numbers using two clocks generated by two individual sources. The apparatus 400B is a version of the flip-flop 400A of FIG. 4 according to an embodiment of the present invention. In the apparatus 400B, a first clock is input to a clock terminal of a first flip-flop 410 and an inverted version of the first clock is input to a clock terminal of a second flip-flop 420, so that the first flip-flop 410 samples a value of a second clock at a rising edge of the first clock and the second flip-flop 420 samples the value of the second clock at a falling edge of the first clock. Outputs of the first and second flip-flops 410 and 420 are combined to generate a signal with random values.

The flip-flop 400A of FIG. 4 samples the second clock at a rising edge of the first clock. However, the apparatus 400B of FIG. 5 samples the second clock both at the rising and falling edges of the first clock, thereby doubling a probability that a jitter in the second clock will be sampled.

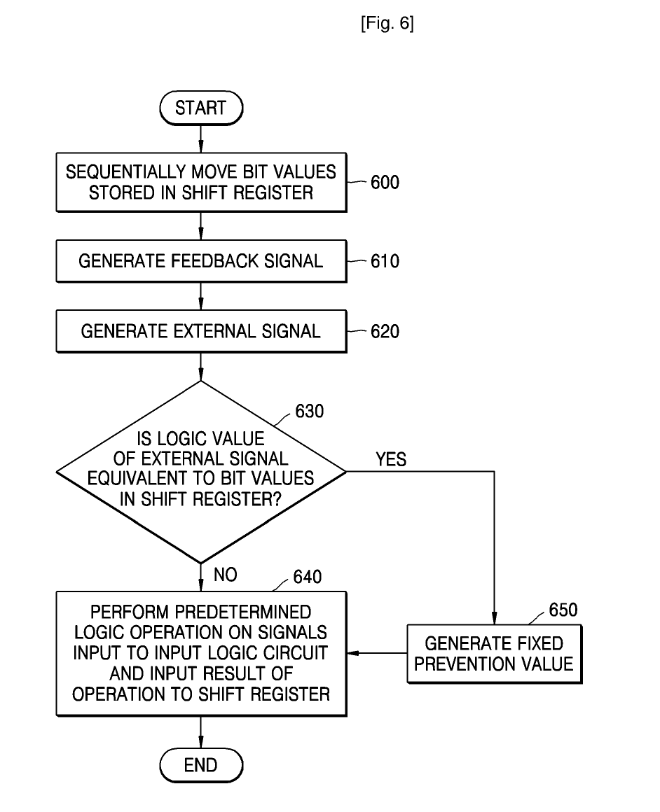

FIG. 6 is a flowchart illustrating a method of generating random numbers using digital logic, according to an embodiment of the present invention. Referring to FIG. 6, bit values stored in a shift register are sequentially moved (step 600). Next, a pre-determined operation is performed on the bit values to generate a feedback signal (step 610).

In this embodiment, the operation of the shift register is the same as that of a shift register included in a conventional LFSR and the method of generating a feedback signal is similar to a conventional method. However, the method of FIG. 6 further includes generating a signal input to the shift register using a new method; generating a fixed value prevention signal, which is output from a fixed value prevention circuit and prevents a value of an output of the shift register from being fixed to a particular value; generating an external signal with random characteristics; combining a value of the signal output from the fixed value prevention circuit, a value of the random signal, and a value of the feedback signal; and inputting the result of the combination to the shift register. Accordingly, it is possible to generate random numbers with unique operational characteristics.

After step 610, the external signal, which is to be input to the shift register, is generated (step 620). Next, it is determined whether a logic value of the external signal is not equivalent to bit values stored in the shift register (step 630). If the logic value of the external signal is equal to the bit values, a predetermined logic operation is performed only on the external signal and the feedback signal, and the result of the logic operation is input to the shift register (step 640).

However, if the logic value of the external signal is equivalent to the bit values, the fixed value prevention signal is generated using a fixed value generation circuit (step 650), and the predetermined logic operation is performed on the external signal, the feedback signal, and the fixed value prevention signal and the result of the logic operation is input to the shift register, returning to step 640. The method of FIG. 6 is as described above with reference to FIGS. 1 through 5, and a detailed description thereof will be omitted.

As described above, according to the present invention, it is possible to randomly generate every possible complete random number that can be statistically generated according to a bit value, only using digital logic. Also, an apparatus for generating random numbers according to the present invention is capable of easily generating random numbers using only digital logic, without an analog circuit and a complicated algorithm. Further, when the digital logic can be fabricated as a compact unit, it is possible to reduce power consumption.

### INDUSTRIAL APPLICABILITY

The present invention may be embodied as a system-on-chip random number generation apparatus, such as an integrated circuit (IC) card, that does not occupy a large space and saves power. Also, the present invention is easy to manufacture like a conventional pseudo random number generating apparatus, and thus applicable to various types of systems.

While this invention has been particularly shown and described with reference to exemplary embodiments thereof, it will be understood by those skilled in the art that various changes in form and details may be made therein without departing from the spirit and scope of the invention as defined by the appended claims.

1. An apparatus for generating random numbers using digital logic, comprising:
a shift register which sequentially moves bit values stored therein;
a feedback circuit which performs a predetermined logic operation on the bit values stored in the shift register to generate a feedback signal;
an external signal generation circuit which generates an external signal input to the shift register;
an input logic circuit which performs a predetermined logic operation on the feedback signal and the external signal and inputs a result of operation to the shift register; and
a fixed value prevention circuit that generates a signal with a value that allows an output of the input logic circuit to have a different value to a value of an output of the shift register and inputs the generated signal to the input logic circuit, when a logic value of the external signal is equivalent to all the bit values stored in the shift register.

3. The apparatus of claim 1, wherein the signal output from the fixed value prevention circuit is at logic high.

4. The apparatus of claim 1, wherein the external signal generation circuit generates a random signal.

5. The apparatus of claim 4, wherein the random signal is generated by sampling a sampled signal generated by a source that is different from a source of a sampling signal.

6. The apparatus of claim 5, wherein sampling is performed both at rising and falling edges of the sampling signal generated by a source that is different from a source of the sampled signal.

7. A method of generating random numbers using digital logic, comprising:
(a) sequentially moving bit values stored in a shift register;
(b) performing a predetermined logic operation on the bit values stored in the shift register to generate a feedback signal;
(c) generating an external signal input to the shift register; and
(d) performing a predetermined operation on the feedback signal and the external signal and inputting a result of the operation to the shift register.

8. The method of claim 7, wherein during (d), the predetermined logic operation is further performed on an output of a fixed value prevention circuit that allows the result of the predetermined logic operation to be different to the bit values of the shift register, when a logic value of the external signal is equivalent to all the bit values stored in the shift register.

9. The method of claim 8, wherein the output of the fixed value prevention circuit is at logic high.

10. The method of claim 7, wherein the external signal is a random signal.

11. The method of claim 10, wherein the random signal is generated by sampling a sampled signal generated by a source that is different from a source of a sampling signal.

12. The method of claim 11, wherein sampling is performed both at rising and falling edges of the sampling signal generated by a source that is different from a source of the sampled signal.
